(19) United States
(12) Patent Application Publication
(10) Pub. No.: US 2012/0312449 A1
(43) Pub. Date: Dec. 13, 2012

(54) BAND SEAL-PREPARATION LIQUID VISCOMETER FOR CAPSULES

(76) Inventor: Isaac Michael Strickland, Whitsett, NC (US)

(21) Appl. No.: 13/156,656

(22) Filed: Jun. 9, 2011

(51) Int. Cl. B32B 37/12; B32B 37/02

(52) U.S. Cl. 156/64; 156/356

(57) ABSTRACT

The present invention is directed to an apparatus for controlling the absolute viscosity of band seal-preparation liquid in a process to apply the band seal-preparation liquid to seal two part capsules comprising a) a first source comprising a band seal-preparation liquid, a second source comprising purified water, a loop connected from said first source, wherein said loop is connected to the first source, and wherein said band seal-preparation liquid is circulated in one direction through said loop from said first source back to said first source; and an apparatus for measuring the absolute viscosity of said band seal-preparation liquid in said loop to produce a absolute viscosity measurement, and applying the band seal-preparation liquid to a two part capsule in order to create a seal band to seal the two parts together.

### FIELD OF THE INVENTION

The present invention relates to capsules, and particularly an apparatus to control the absolute viscosity of band seal-preparation liquid, such as gelatin, in a process to make the band seals to seal two part capsules. Such band seals for a hard capsule may be filled with a liquid or a powder such as polyethylene glycol (hereinafter sometimes also referred to as “PEG”); and a liquid for preparing the band seal. The present invention further relates to a hard capsule filled with PEG and sealed with a band seal, and a process for preparing the same.

### BACKGROUND ART

Filled hard capsules generally are made of two parts, a cap and body, which are joined together and sealed with a band of band seal-preparation liquid, which is generally referred to as a seal band. Such hard capsules are generally filled with pharmaceuticals, health foods, or nutritional supplements. Filled hard capsules require that leakage, or seepage, of content is prevented, and thus free from liquid leakage problems; hard capsules that leak may suffer deterioration of their oxygen- or water-susceptible contents if oxygen and/or water enter through the gap between the body and cap of the capsule. Therefore, a filled hard capsule in which the entry of oxygen and/or water through the gap is prevented requires proper sealing of the cap and body parts of the capsule.

Band seals have been used to solve this problem. The band seal is a sealant (sealing agent) used to seal a fitting portion between the body and cap of a hard capsule after the contents are inserted in the capsule. Band seals are generally made of band seal-preparation liquid, such as gelatin, along with purified water and a colorant. An important part of making band seals is to have the proper viscosity of the band seal-preparation liquid when the band seal-preparation liquid is applied to seal the cap and body of the capsule.

There remains a need to provide a process in which to control the viscosity of the band seal-preparation liquid being applied to the hard capsule in order to seal band the capsule.

### SUMMARY

An object of the present invention is to provide an apparatus for controlling the absolute viscosity of band seal-preparation liquid in a process for banding capsules comprising
a first source comprising a band seal-preparation liquid wherein said band seal-preparation liquid has an absolute viscosity in a range from a low level absolute viscosity to a high level absolute viscosity, wherein said low level absolute viscosity is less than said high level absolute viscosity;
a second source comprising purified water;
a loop connected from said first source, wherein said loop is connected to the first source, and wherein said band seal-preparation liquid is circulated in one direction through said loop from said first source back to said first source; and
an apparatus for measuring the absolute viscosity of said band seal-preparation liquid in said loop to produce a absolute viscosity measurement, wherein said apparatus for measuring the absolute viscosity of said gelatin comprises at least two set points including a low level viscosity set point and a high level viscosity set point, wherein the difference between the low level viscosity set point and the high level viscosity set point, wherein said absolute viscosity measurement of the gelatin in the loop is compared to said range of absolute viscosity to determine if said absolute viscosity measurement of the band seal-preparation liquid in the loop is less than the low level viscosity, within the range, or more than the high level viscosity set point;
a feedback means wherein.
   if the measured absolute viscosity of the band seal-preparation liquid in said loop is less than said low level set point, addition of an amount of gelatin to the first source comprising a band seal-preparation liquid to cause the band seal-preparation liquid in the first source to have an absolute viscosity in range from a low level absolute viscosity and a high level absolute viscosity; or
   if the measured absolute viscosity of the band seal-preparation liquid in said loop is more than said low level set point, addition of an amount of purified water to the first source to cause the band seal-preparation liquid in the first source to have an absolute viscosity in range from a low level absolute viscosity and a high level absolute viscosity.
applying the band seal-preparation liquid to a two part capsule in order to create a seal band to seal the two parts together.

Numerous other features and advantages of the present invention will appear from the following description.

### BRIEF DESCRIPTION OF THE FIGURES

The foregoing and other features, aspects, and advantages of the present invention will become better understood with regard to the following description, appended claims, and accompanying drawings where:

FIG. 1 is a flowchart of the band seal-preparation liquid viscometer produced in accordance with an embodiment of the current invention;

FIG. 2 is a schematic view of the band seal-preparation liquid viscometer produced in accordance with an embodiment of the current invention in communication with a band sealing apparatus; and

FIG. 3 is a schematic view of an embodiment of the band seal-preparation liquid viscometer produced in combination with a band sealing apparatus in an embodiment of the current invention.

### DEFINITIONS

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The term “band seal” refers to a band-shaped film for sealing a filled hard capsule formed by joining a cap to a body, wherein the sealing film is formed by applying a band seal-preparation liquid to the outer peripheral surface portions of the body and cap in such a manner that the cut portion of the cap is approximately at the center of the application and the band seal-preparation liquid applied extends over both sides of the edge of the cap, followed by drying.

The term “band seal preparation liquid” refers to a liquid for preparing the band seal, more specifically, a solution of band seal-forming components in solvent comprising purified water as a main component wherein the liquid generally comprises gelatin and optionally a colorant such as a suitable dye.

The term “band sealing properties” refers to a property of the band seal capable of forming a film to seal the body and cap of a hard capsule (film-forming capability) and a property thereof capable of preventing content leakage through the fitting portion between the body and cap of the capsule by sealing with the film (leakage-preventing capability) or a tamper evidence seal showing the capsule has not been opened. The “band sealing properties” may be evaluated by applying a band seal-preparation liquid sample to seal (band-seal) the fitting portion between the cap and body of a capsule filled with polyethylene glycol (PEG400) having an average molecular weight of 400; leaving the capsule on white paper at 25° C. in a relative humidity of 40% for 12 hours; and checking whether the contents have leaked through the band seal portion.

The term “purified water” refers to water from any source that is physically processed to remove impurities of larger than 0.01 micron wherein the water may be purified by processes including reverse osmosis, carbon filtration, microfiltration, ultrafiltration, ultraviolet oxidation or electrodialysis.

These terms may be defined with additional language in the remaining portions of the specification.

### DETAILED DESCRIPTION

While typical aspects of embodiment and/or embodiments have been set forth for the purpose of illustration, this Detailed Description and the accompanying drawings should not be deemed to be a limitation on the scope of the invention. Accordingly, various modifications, adaptations, and alternatives may occur to one skilled in the art without departing from the spirit and scope of the present invention. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The present invention is directed to an apparatus for controlling the absolute viscosity of band seal-preparation liquid in a process to make seal band capsules comprising
a first source comprising a band seal-preparation liquid wherein said band seal-preparation liquid has an absolute viscosity in a range from a low level absolute viscosity to a high level absolute viscosity, wherein said low level absolute viscosity is less than said high level absolute viscosity;
a second source comprising purified water;
a loop connected from said first source, wherein said loop is connected to the first source, and wherein said gelatin is circulated in one direction through said loop from said first source back to said first source; and
an apparatus for measuring the absolute viscosity of said band seal-preparation liquid in said loop to produce a absolute viscosity measurement, wherein said apparatus for measuring the absolute viscosity of said band seal-preparation liquid comprises at least two set points including a low level viscosity set point and a high level viscosity set point, wherein the difference between the low level viscosity set point and the high level viscosity set point, wherein said absolute viscosity measurement of the gelatin in the loop is compared to said range of absolute viscosity to determine if said absolute viscosity measurement of the band seal-preparation liquid in the loop is less than the low level viscosity, within the range, or more than the high level viscosity set point;
a feedback means wherein.
   i. if the measured absolute viscosity of the band seal-preparation liquid in said loop is less than said low level set point, addition of an amount of band seal-preparation liquid to the first source comprising a band seal-preparation liquid to cause the band seal-preparation liquid in the first source to have an absolute viscosity in range from a low level absolute viscosity and a high level absolute viscosity; or
   ii. if the measured absolute viscosity of the band seal-preparation liquid in said loop is more than said low level set point, addition of an amount of purified water to the first source to cause the band seal-preparation liquid in the first source to have an absolute viscosity in range from a low level absolute viscosity and a high level absolute viscosity
applying the band seal-preparation liquid to a two part capsule in order to create a seal band to seal the two parts together.

As set forth above, the band seal-preparation liquid of the present invention may be used to form the band seal on a hard capsule. The band seal-preparation liquid may be prepared by dissolving the band seal component(s) in purified water, a hydrophilic solvent, or a mixture of water and a hydrophilic solvent at room temperature, or while heating (at about 30° C. to about 60° C.). A mixture of purified water and a hydrophilic solvent may be used. Examples of hydrophilic solvents include organic solvents that are compatible with purified water. Specific examples thereof include lower alcohols having 1 to 6 carbon atoms, such as ethanol, and isopropanol. When a mixture of purified water and a hydrophilic solvent is used to prepare a band seal-preparation liquid, the proportion of the hydrophilic solvent in the mixture may be, for example, from about 5 to about 80 wt. %, or from about 8 to about 65 wt. %, or from about 10 to about 50 wt. %, based on the total weight of the mixture as 100 wt. %.

A band seal-preparation liquid may be gelatin. They are formed from a film of a composition comprising gelatin as a base, a plasticizer (e.g., glycerin or sorbitol), opacifying agent, dye, pigment, and other addenda. In one embodiment, the gelatin may be hydroxypropyl methyl cellulose (HPMC). More particularly, in one appropriate formulation of the cellulose ether film for forming band seals, carrageenan is used as a gelling agent for HPMC, and a potassium or calcium ion is incorporated as a gelling aid in the form of a water-soluble compound such as potassium chloride or calcium chloride.

HPMC is specified in the Pharmacopoeia of Japan. In the capsule shell application, it is recommended to use the pharmacopoeia-specified products. For HPMC, the Pharmacopoeia specifies three types, hydroxypropyl methyl cellulose 2208, hydroxypropyl methyl cellulose 2906, and hydroxypropyl methyl cellulose 2910, depending on the contents of MO and HPO groups. It is specified that hydroxypropyl methyl cellulose 2208 contains 19 to 24 wt % of MO groups and 4 to 12 wt % of HPO groups in a total of 23 to 36 wt %; hydroxypropyl methyl cellulose 2906 contains 27 to 30 wt % of MO groups and 4 to 7.5 wt % of HPO groups in a total of 31 to 37.5 wt %, and hydroxypropyl methyl cellulose 2910 contains 28 to 30 wt % of MO groups and 7 to 12 wt % of HPO groups in a total of 35 to 42 wt %. Any of these celluloses may be used in the practice of the invention as long as the total content of MO and HPO groups is up to 37.6 wt %. Also acceptable are mixtures in which any two or more of these celluloses are mixed to adjust the total content of MO and HPO groups to that range.

The gelling agent used may be selected from among, for example, carrageenan, tamarind seed polysaccharide, pectin, curdlan, furcellaran, gellan gum, and mixtures thereof. Of these, carrageenan is especially preferred because it has a high gel strength and exhibits good gelling properties in the co-presence of a specific ion so that it may achieve effective gelation even when added in small amounts. While there are known three types: kappa-carrageenan or iota-carrageenan and lambda-carrageenan, the invention recommends to use kappa-carrageenan and/or iota-carrageenan which have a good gelation ability.

The amount of the gelling agent used is not critical and may be suitably determined in accordance with the type of cellulose ether and gelling agent, the intended application of film, and film forming method. When used in band seals, for example, it is recommended to use about 0.05 to 25 parts, and especially about 0.25 to 15 parts by weight of the gelling agent per 100 parts by weight of the cellulose ether.

The band seal-preparation liquid is usually adjusted to a final viscosity of from about 100 to about 5,000 mPas. In the present invention, the viscosity refers to a viscosity as measured with a pass through viscometer.

By using the band seal-preparation liquid having a viscosity within the above-mentioned range, a band seal having a high sealing force can be formed on the fitting portion between the body and cap of the filled hard capsule. Furthermore, when producing the band seal, inconvenient thread formation does not occur and the liquid is easy to handle. When the viscosity of the band seal-preparation liquid is remarkably lower than the above-mentioned range (100 to 5,000 mPas), it is difficult to apply the band seal-preparation liquid to the fitting portion of the filled hard capsule without dripping. As a result, a band seal with an excellent sealing force capable of achieving the effect of the present invention may not be formed. When the viscosity of a band seal-preparation liquid is remarkably higher than the above-mentioned range (100 to 5,000 mPas), the viscosity is too high to form a band seal using a machine. The band seal-preparation liquid has a viscosity of from about 125 to about 4,700 mPas, or from about 150 to about 4,500 mPas.

When the band seal contains sorbitol, the concentration of sorbitol in the band seal-preparation liquid can be appropriately selected according to the above-mentioned proportion of sorbitol in the band seal. More specifically, the band seal-preparation liquid is preferably prepared in such a manner that the resulting band seal (100 wt %) contains sorbitol in a concentration of from about 0.01 to about 70 wt %, or from about 0.01 to about 35 wt %, or from about 0.01 to about 30 wt %, or from about 1 to about 30 wt %, considering that the band seal-preparation liquid preferably has a viscosity of from about 100 to about 5,000 mPas.

If no adhesion of the content to the white paper, i.e., no content leakage, the liquid is evaluated as “having band sealing properties”. If any content leakage is observed in (a) or (b), the liquid is evaluated as “having no band sealing properties”.

The band seal may optionally contain, in addition to the above components, additives usually used in the preparation of hard capsules, such as coloring agents (e.g., titanium oxide, red iron oxide, and coal-tar based coloring agents), opacifying agents, and fragrances. Considering the band sealing properties, the proportion of such additives in the band seal can be appropriately selected from the range of from about 0.1 to about 7 wt %.

The band seal of the invention is suitable as a band seal for a hard capsule filled with polyethylene glycol (PEG) or a composition comprising a polyethylene glycol. PEG is not particularly limited, and examples thereof include PEG having an approximate average molecular weight of about 20,000 or less.

The contents of the hard capsule may be PEG or any composition that comprises at least PEG, as described above. Examples of such compositions include, but are not limited to, drugs for human beings or animals, quasi drugs, cosmetics, and foods. Although the proportion of PEG in the composition is not particularly limited, it is usually from about 0.01 to about 99.99 wt %, or from about 0.05 to about 99.95 wt %.

When the hard capsule is filled with a pharmaceutical, the pharmaceutical may be, for example, one or two or more kinds of pharmaceutical ingredients selected from nourishment tonics, antipyretics/analgesics/anti-inflammatory drugs, psychotropic drugs, anti-anxiety drugs, antidepressant drugs, hypnotic/sedative drugs, antispasmodic drugs, drugs acting on the central nervous system, cerebral metabolism improvers, cerebral circulation improvers, antiepileptic drugs, sympathetic nerve stimulants, digestives, antacids, antiulcer drugs, antitussive/expectorant drugs, antiemetic drugs, respiration promoters, bronchodilators, antiallergic drugs, drugs for dentistry and oral cavity, antihistamic drugs, cardiotonic drugs, antiarrhythmic drugs, diuretic drugs, antihypertensive drugs, vasoconstrictors, coronary vasodilators, peripheral vasodilators, antihyperlipidemic drugs, cholagogues, antibiotics, chemotherapeutic drugs, antidiabetic drugs; antiosteoporotic drugs, antirheumatic drugs, skeletal muscle relaxants, spasmolytic drugs, hormone preparations, alkaloid narcotics, sulfa drugs, anti-gout drugs, anticoagulant drugs, antineoplastic drugs, and the like. Such pharmaceutical ingredients are not particularly limited, and a wide variety of known ones can be used.

When the hard capsule is filled with a food, examples of such foods include, but are not limited to, functional ingredients such as docosahexaenoic acid, eicosapentaenoic acid, .alpha.-lipoic acid, royal jelly, isoflavone, agaricus, acerola, aloe, aloe vera, turmeric, L-carnitine, oligosaccharide, cacao, catechin, capsaicin, chamomile, agar, tocopherol, linolenic acid, xylitol, chitosan, GABA, citric acid, chlorella, glucosamine, ginseng, coenzyme Q10, brown sugar, collagen, chondroitin, bracket fungus, squalene, stevia, ceramide, taurine, saponin, lecithin, dextrin, Houttuynia cordata, niacin, Bacillus natto, bittern, lactic acid bacteria, saw palmetto, honey, Coix lacrymajobi var. ma-yuen, ume extract, pantothenic acid, hyaluronic acid, vitamin A, vitamin K, vitamin C, vitamin D, vitamin B1, vitamin B2, vitamin B6, vitamin B12, quercetin, protein, propolis, mulukhiya, folic acid, lycopene, linoleic acid, rutin, and Ganoderma lucidum.

The filling of the contents in the hard capsule may be performed by using a per se known capsule-filling machine, such as a fully automatic capsule-filling machine (model name: “LIQFIL super 80/150”, product of Shionogi Qualicaps Co., Ltd.), and a capsule-filing and sealing machine (model name: LIQFIL super FS, product of Shionogi Qualicaps Co., Ltd.), etc.

Pullulan, hemicellulose, corn starch, and carboxymethyl cellulose are widely used as additives for foods, drugs, cosmetics, etc., and are commercially available. Hemicellulose is preferably a soybean-derived hemicellulose. “Hemilose”, a product of Fuji Oil Co., Ltd., is particularly preferable. Water-soluble salts thereof may be any salt that dissolves in water. Examples thereof include alkali metal salts such as sodium salts and potassium salts. In general, the hard capsule can be produced by an injection molding method or a dipping method. The dipping method is a capsule manufacturing method that makes: use of the gelation of the hard capsule film-forming base material (hard capsule-preparation liquid) by a temperature difference. If the base material has no gelling capability, a gelling agent is added.

Sealing of the hard capsules can be conducted by use of a per se known capsule filling and sealing machine, such as the above-mentioned capsule filling and sealing machine (model name: HICAPSEAL 40/100, product of Shionogi Qualicaps Co., Ltd.). These machines are fully automatic capsule sealing machines, which perform the banding of two-part capsules.

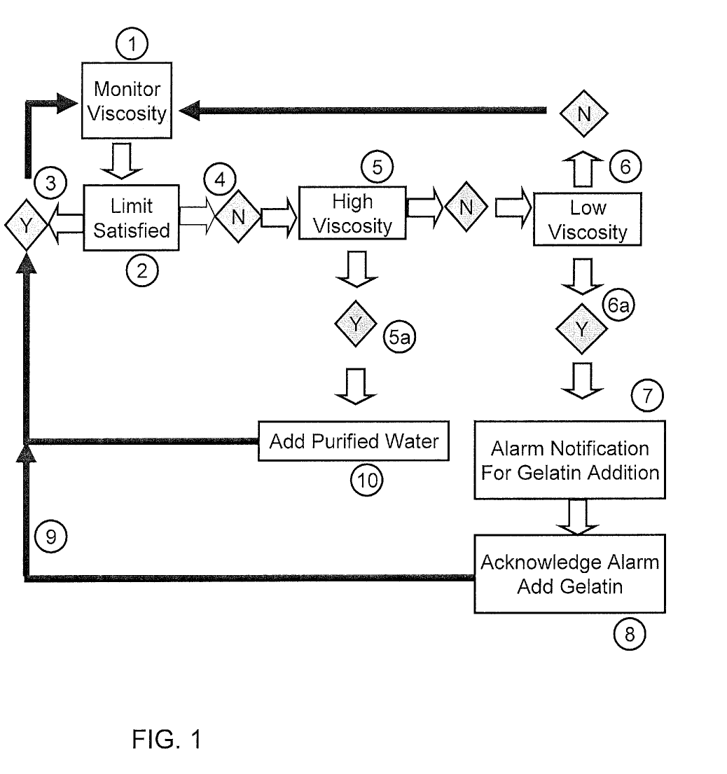

Embodiments of the above-described invention can be found in the Figures. FIG. 1 is a flowchart of one embodiment of a band seal-preparation liquid viscometer as described in the current invention. The viscosity of the gelatin is monitored (1) to determine (2) whether the viscosity is higher or lower than the predetermined viscosity range. If the viscosity is within the predetermined limits (3), the monitor will continue to monitor the viscosity (1). If the viscosity is outside of these limits (4), the sensor determines whether the viscosity is too high (5) or too low (6). If the viscosity is too high (5a), the band seal-preparation liquid viscometer signals the band sealing apparatus (not shown) to add purified water (10) to the gelatin holding tank (not shown) of the band sealing apparatus (not shown). If the viscosity is too low (6a), the apparatus gives an alarm (7) notifying the operator that the addition of gelatin to the gelatin holding tank of the band sealing apparatus is necessary. The operator may then acknowledge (8) the alarm (7), at which point the operator manually adds gelatin to the gelatin holding tank. If, during these steps, the viscosity is determined to be within the predetermined viscosity range, the monitor (1) will continue to monitor the gelatin viscosity (9). As shown in the flowchart in FIG. 1, the viscosity is continually monitored during the above steps.

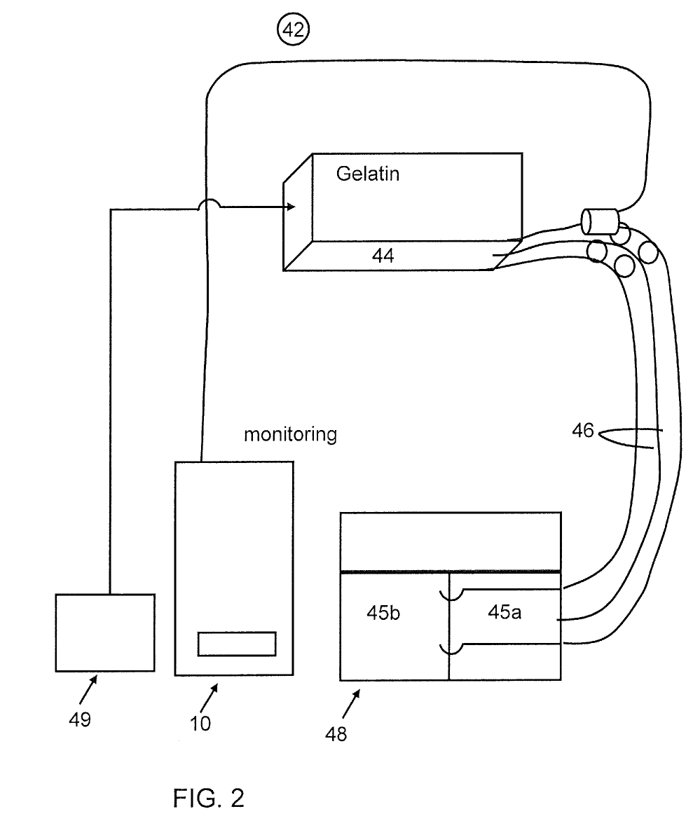

FIG. 2 represents the schematic view of the interplay between the band seal-preparation liquid viscometer according to the current invention and a band sealing apparatus (44). A band seal-preparation liquid viscometer according to the present invention (10) is a stand alone attachment to the band sealing apparatus. The band sealing apparatus (44) has at least one gelatin holding tank (45a) and may have an additional gelatin holding tank (45b). The gelatin holding tanks (45a) (45b) are in communication with each other to allow gelatin (48) from one tank (45b) to move into the other gelatin holding tank (45a) if the band seal-preparation liquid viscometer according to the current invention indicates that the viscosity is too low. The gelatin holding tank (45a) is in communication with the band sealing apparatus (44) via conduits (46) for the passage of the gelatin to the band sealing apparatus (44). The movement of the gelatin (48) may be monitored (47) by a monitoring means. The gelatin holding tanks (45a) (45b) are also in communication with a purified water holding tank (49) which allows purified water to move into the gelatin holding tanks (45a) (45b) if the band seal-preparation liquid viscometer according to the current invention indicates that the viscosity is too high.

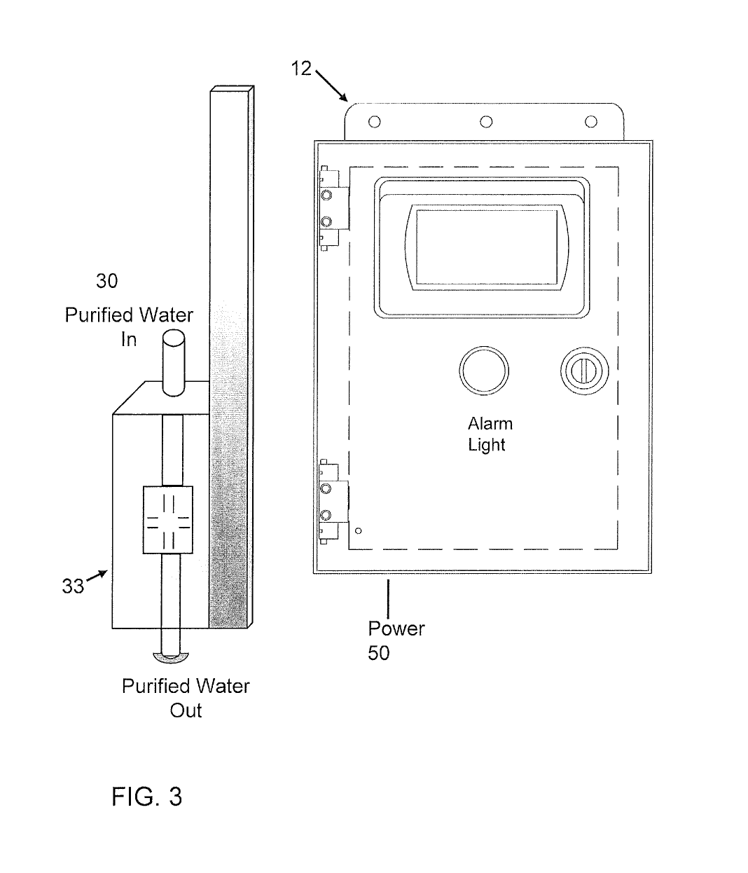

FIG. 3 shows some element of a band seal-preparation liquid viscometer according to the current invention produced in combination with a band sealing apparatus. In this embodiment, there is a touch pad controller (12) which includes high viscosity and low viscosity indicators to alert the operator when the viscosity of the gelatin in the gelatin holding tank (not shown) is outside of the predetermined viscosity range. The controller (12) may further include an alarm to alert the operator when it is necessary to add gelatin to the gelatin holding tank and a means for the operator to acknowledge the need for gelatin to be added and allowing the gelatin to be added to the gelatin holding tank (not shown). This embodiment may include a means for starting and a stopping the monitoring of the gelatin and/or the sealing of the capsules. This embodiment may additionally include a means for introducing purified water to the gelatin holding tank (not shown). In this embodiment, there may be an inlet (30) from the purified water tank (33), and an outlet for transferring the purified water to the gelatin holding tank (not shown). The sensor of the current embodiment may incorporate a Cambridge Model SPC4/L372J sensor which senses the viscosity of the gelatin in the gelatin holding tank (not shown). This embodiment would additionally have a power source (50). In aspects of this embodiment of the current invention, there are additionally a viewing window for viewing the sealing of the capsules and a touch screen control panel for setting the viscosity ranges as well as any other commands for the sealing of the capsules and/or the operation of the embodiment.

While the invention has been herein shown and described in what is presently conceived to be the most practical and preferred embodiment thereof, it will be apparent to those of ordinary skill in the art that many modifications may be made thereof within the scope of the invention, which scope is to be accorded the broadest interpretation of the appended claims so as to encompass all equivalent products and methods.

What is claimed is:

1. An apparatus for controlling the absolute viscosity of gelatin in a process to apply the band seal-preparation liquid to seal two part capsules comprising
a) a first source comprising a band seal-preparation liquid wherein said band seal-preparation liquid has an absolute viscosity in a range from a low level absolute viscosity to a high level absolute viscosity, wherein said low level absolute viscosity is less than said high level absolute viscosity;
b) a second source comprising purified water;
c) a loop connected from said first source, wherein said loop is connected to the first source, and wherein said band seal-preparation liquid is circulated in one direction through said loop from said first source back to said first source; and
d) an apparatus for measuring the absolute viscosity of said band seal-preparation liquid in said loop to produce a absolute viscosity measurement, wherein said apparatus for measuring the absolute viscosity of said gelatin comprises at least two set points including a low level viscosity set point and a high level viscosity set point, wherein the difference between the low level viscosity set point and the high level viscosity set point, wherein said absolute viscosity measurement of the band seal-preparation liquid in the loop is compared to said range of absolute viscosity to determine if said absolute viscosity measurement of the gelatin in the loop is less than the low level viscosity, within the range, or more than the high level viscosity set point;
e) a feedback means wherein.
i) if the measured absolute viscosity of the band seal-preparation liquid in said loop is less than said low level set point, addition of an amount of gelatin to the first source comprising a band seal-preparation liquid to cause the band seal-preparation liquid in the first source to have an absolute viscosity in range from a low level absolute viscosity and a high level absolute viscosity; or
ii) if the measured absolute viscosity of the band seal-preparation liquid in said loop is more than said high level set point, then said feedback means adds an amount of purified water to the first source to cause the band seal-preparation liquid in the first source to have an absolute viscosity in range from a low level absolute viscosity and a high level absolute viscosity
f) applying the band seal-preparation liquid to a two part capsule in order to create a seal band to seal the two parts together.

2. The apparatus for controlling the absolute viscosity of band seal-preparation liquid in a process to make capsules of claim 1 wherein the apparatus for measuring the absolute viscosity of said band seal-preparation liquid is an in-line flow through viscometer.

3. The apparatus for controlling the absolute viscosity of band seal-preparation liquid in a process to make capsules of claim 1 wherein the source of the band seal-preparation liquid is a tank.

4. The apparatus for controlling the absolute viscosity of band seal-preparation liquid in a process to make capsules of claim 1 wherein the first source comprises wherein the first source comprises
a. an outlet port and
b. an inlet port.

5. The apparatus for controlling the absolute viscosity of band seal-preparation liquid in a process to make capsules of claim 1 wherein the band seal-preparation liquid circulation loop has a flow rate of from about 0.5 to about 1.0 ft/sec.

6. The apparatus for controlling the absolute viscosity of band seal-preparation liquid in a process to make capsules of claim 1 wherein the source of the purified water is a tank.

7. The apparatus for controlling the absolute viscosity of band seal-preparation liquid in a process to make capsules of band seal-preparation liquid of claim 1 wherein the in-line flow through viscometer comprises a heated jacket.

8. The apparatus for controlling the absolute viscosity of band seal-preparation liquid in a process to make capsules of band seal-preparation liquid of claim 1 wherein the range of the absolute viscosity is from about 100 cPs to about 1,000 cPs.

9. A capsule sealing machine comprising the apparatus for controlling the absolute viscosity of band seal-preparation liquid in a process to make capsules of claim 1.

10. A method of manufacturing hard capsules comprising the apparatus for controlling the absolute viscosity of band seal-preparation liquid in a process to make capsules of claim 1.

11. The apparatus for controlling the absolute viscosity of band seal-preparation liquid in a process to make capsules of claim 1 wherein the band seal-preparation liquid is a gelatin.
